(19) United States
(12) Patent Application Publication
(10) Pub. No.: US 2022/0392085 A1
(43) Pub. Date: Dec. 8, 2022

(54) SYSTEMS AND METHODS FOR UPDATING THREE-DIMENSIONAL MEDICAL IMAGES USING TWO-DIMENSIONAL INFORMATION

(71) Applicant: Nuvasive, Inc., San Diego, CA (US)

(72) Inventors: Eric FINLEY, San Diego, CA (US); Yehiel SHILO, San Diego, CA (US)

(21) Appl. No.: 17/760,694

(22) PCT Filed: Sep. 24, 2020
(86) PCT No.: PCT/US2020/052408

§ 371 Date: Mar. 15, 2022

Related U.S. Application Data
(60) Provisional application No. 62/905,295, filed on Sep. 24, 2019.
(60) Provisional application No. 62/905,905, filed on Sep. 25, 2019.

(51) Int. Cl. G06T 7/30; G06T 7/11

(52) U.S. Cl. CPC G06T 7/30; G06T 7/11; G06T 2207/10081; G06T 2207/30012; G06T 2207/20084; G06T 2207/30204

(57) ABSTRACT

Disclosed herein are systems, methods, and media for updating preoperative 3D dataset using at least two 2D intraoperative images to reflect changes in anatomical features caused by patient movement.

### CROSS REFERENCE

This application is a non-provisional of, and claims the benefit of, U.S. Provisional patent application Ser. Nos. 62/905,295 filed Sep. 24, 2019 and 62/905,905 filed Sep. 25, 2019, the entire contents of which are hereby expressly incorporated by reference into this disclosure as if set forth in its entirety herein.

### BACKGROUND

Preoperative imaging can be a routine process that provides various clinical benefits for patients to undergo spinal surgeries. Different imaging modalities such as computerized tomography (CT), magnetic resonance imaging (MRI), and ultrasound may be used for preoperative imaging. Coverage of a three-dimensional (3D) volume in preoperative imaging may provide significantly more information than two-dimensional (2D) slices thus better facilitate planning, diagnostic, operational, or predictive decisions by the surgeon.

### SUMMARY

3D preoperative images are often taken before a patient is positioned on a surgical table for a surgical procedure. For example, the patient may be imaged in a different room a couple of days before the surgery. Thus, patient movement is inevitable between when the preoperative 3D scan is taken and when the patient is positioned for surgery. The patient's movement may render the 3D preoperative images inaccurate if not useless in guiding surgical movement of the surgeon during the operation. However, retaking the 3D dataset may be inconvenient (e.g., the patient may need to be moved out of the operation room), costly, time-consuming, and may also introduce undesired ionizing radiation to the patient. Instead, 2D intraoperative images may provide accurate anatomical information, however, comparing with 3D images, the information can be very limited and oftentimes not enough for the surgeon to take a well-informed surgical action. Thus, there is an urgent and unmet need to provide reliable 3D intraoperative images without increase in cost, imaging and preparation time, and radiation dosage to the patient.

Disclosed herein are systems, methods, and media for updating 3D preoperative images, e.g., CT scan, to include changes caused by patient movement to match anatomical information during an operation. The advantages of the systems, methods, and media include no need to retake the 3D scan thus saving cost and time for the patient and surgeon. Further, the systems, methods, and media herein advantageously reduce ionizing radiation to the patient by only requiring as few as two 2D intraoperative images for updating the 3D scan. The updated 3D scan can correctly represent the current anatomical information during a surgical procedure, so that it can be used to assist the surgeon in making surgical moves and tracking surgical instruments with respect to the anatomical features. As a non-limiting example, the preoperative 3D dataset can be updated to reflect increased distance between two adjacent vertebrae after insertion of an implant therebetween, and the surgeon can rely on the updated 3D dataset to track pedicle screws or retractors for spine alignment or spinal fusion procedures after implantation. As disclosed herein the preoperative images and the intraoperative images can be taken with identical or different imaging modalities.

Disclosed herein are systems, methods, and media for updating 3D images, e.g., preoperative CT scan, to include changes caused by patient movement to match anatomical information during an operation, using intraoperative ultrasound images, the ultrasound images can be 2D, 3D, or even 4D. The advantages of the systems, methods, and media include no need to retake the 3D scan or any 2D scan with ionizing radiation thus advantageously reduce ionizing radiation to the patient. The updated 3D scan can correctly represent the current anatomical information intraoperatively, so that it can be used to assist the surgeon in making surgical moves and tracking surgical instruments with respect to the anatomical features. As a non-limiting example, the preoperative 3D dataset can be updated to reflect increased distance between two adjacent vertebrae after insertion of an implant therebetween, and the surgeon can use the updated 3D dataset to track pedicle screws or retractors for spine alignment or spinal fusion procedures after implantation. As disclosed herein the preoperative images and the intraoperative images can be taken with identical or different imaging modalities.

In one aspect, disclosed herein is a method for updating three-dimensional medical imaging data of a subject, the method comprising: receiving, by a computer, a three-dimensional dataset of the subject; generating, by the computer, a segmented three-dimensional dataset comprising: segmenting one or more anatomical features in the three-dimensional dataset; acquiring, by an image capturing device, two two-dimensional images of the subject from two intersecting imaging planes; generating, by the computer, two undistorted two-dimensional images corresponding to the two two-dimensional images based on three-dimensional coordinates of the two two-dimensional images; optionally removing, by the computer, one or more objects from the two undistorted two-dimensional images, thereby generating two object-free two-dimensional images; registering, by the computer, the segmented three-dimensional dataset with the two object-free two-dimensional images; and optionally updating, by the computer, the three-dimensional dataset using information of the registration. In some cases, the three-dimensional dataset of the subject comprises a computerized tomography (CT) scan of the subject. In some cases, the CT scan of the subject is obtained before a medical operation when the subject is in a first position and the two two-dimensional images of the subject are taken when the subject is in a second position. In some cases, the one or more anatomical features comprise one or more vertebrae of the subject. In some cases, generating the segmented three-dimensional dataset further comprising, subsequent to segmenting the one or more anatomical features from the three-dimensional dataset, generating a plurality of single feature three-dimensional datasets using the one or more segmented anatomical features. In some cases, generating the segmented three-dimensional dataset further comprising, subsequent to generating the plurality of single feature three-dimensional datasets, combining the plurality of single feature three-dimensional datasets into a single three-dimensional dataset. In some cases, combining the plurality of single feature three-dimensional datasets comprising applying a transformation to each of the plurality of the single feature three-dimensional dataset. In some case, the transformation comprises three-dimensional translation, rotation, or both. In some cases, generating the plurality of single feature three-dimensional data comprises smoothing edges of the anatomical features using Poisson blending. In some cases, segmenting the one or more anatomical features comprising using a neural network algorithm and automatically segmenting the one or more anatomical features by the computer. In some cases, the image capturing device is a C-arm. In some cases, a first of the two two-dimensional images of the subject is taken at a sagittal plane of the subject, and a second of the two-dimensional images is taken at a coronal plane of the subject. In some cases, the two intersecting imaging planes are perpendicular to each other. In some cases, generating the two undistorted two-dimensional images corresponding to the two two-dimensional images comprises using a marker attached to the one or more anatomical features, and generating one or more calibration matrices based on one or more of: two-dimensional coordinates of the two two-dimensional images, coordinates of the marker, position and orientation of the marker, an imaging parameter of the image capturing device, and information of the subject. In some cases, the two two-dimensional images include at least part of the marker therewithin. In some cases, the marker includes tracking markers that are detectable by a second image capturing device. In some cases, the second image capturing device comprises an infrared detector, and the tracking markers are configured to reflect infrared lights. In some cases, the one or more objects are opaque objects external to the one or more anatomical features. In some cases, removing the one or more opaque objects utilizes a neural network algorithm. In some cases, removing the one or more opaque objects is automatically performed by the computer. In some cases, registering the segmented three-dimensional dataset with the two object-free two-dimensional images comprising: a) obtaining a starting point optionally automatically using the three-dimensional dataset or the segmented three-dimensional dataset of the subject; b) generating a digitally reconstructed radiography (DRR) from the segmented three-dimensional dataset; c) comparing the DRR with the two object-free two-dimensional images; d) calculating a value of a cost function based on the comparison of the DRR with the two metal-free two-dimensional images; e) repeating b)-d) until the value of the cost function meets a predetermined stopping criterion; and f) outputting one or more DRRs based on the value of the cost function. In some cases, the information of the registration comprises one or more of: the one or more DRRs and parameters to generate the one or more DRRs from the segmented three-dimensional dataset. In some cases, the method further comprises displaying the updated three-dimensional dataset to a user using a digital display. In some cases, the method further comprises superimposing a medical instrument on the updated three-dimensional dataset to allow a user to track the medical instrument. In some cases, the two two-dimensional images of the subject are taken during a medical operation.

In another aspect, disclosed herein is a method for updating preoperative computerized tomography (CT) of a subject, the method comprising: receiving, by a computer, a three-dimensional dataset of the subject; generating, by the computer, a segmented three-dimensional dataset comprising: segmenting one or more vertebrae from the three-dimensional dataset; generating a plurality of single vertebra three-dimensional data using the one or more segmented vertebrae; and optionally combining the plurality of single vertebra three-dimensional datasets into a single three-dimensional dataset; acquiring, by an image capturing device, two two-dimensional images of the subject from two intersecting imaging planes; generating, by the computer, two undistorted two-dimensional images corresponding to the two two-dimensional images based on three-dimensional coordinates of the two two-dimensional images; removing, by the computer, one or more metal objects from the two two-dimensional images, the one or more metal objects external to the one or more anatomical features, thereby generating two metal-free two-dimensional images; registering, by the computer, the segmented three-dimensional dataset with the two metal-free two-dimensional images comprising: a) obtaining a starting point optionally automatically using the three-dimensional coordinates of the two-dimensional images; b) generating a digitally reconstructed radiographies (DRR) from the segmented three-dimensional dataset; c) comparing the DRR with the two metal-free two-dimensional images; d) calculating a value using a pre-determined cost function based on the comparison of the DRR with the two metal-free two-dimensional images; e) repeating b)-d)) until the value of the cost function meets a predetermined stopping criterion; and f) outputting one or more DRRs based on the value of the cost function; and updating, by the computer, the three-dimensional dataset using the one or more DRRs.

In yet another aspect, disclosed herein is a computer-implemented system comprising: an image capturing device; a digital processing device comprising a processor, a memory, and an operating system configured to perform executable instructions, the digital processing device in digital communication with the image capturing device; and a computer program stored in the memory including instructions executable by the processor of the digital processing device to create application for updating three-dimensional medical imaging data, comprising: a software module configured to receive a three-dimensional dataset of the subject; a software module configured to generate a segmented three-dimensional dataset comprising: segment one or more anatomical features from the three-dimensional dataset; a software module configured to acquire, by the image capturing device, two two-dimensional images of the subject taken from two intersecting imaging planes; a software module configured to generate three-dimensional coordinates for the two two-dimensional images; a software module configured to optionally remove one or more objects from the two two-dimensional images, the one or more objects external to the one or more anatomical features, thereby generating two object-free two-dimensional images (i.e. two-dimensional images free of objects other than the one or more anatomical features); a software module configured to register the segmented three-dimensional dataset with the two object-free two-dimensional images; and a software module configured to optionally update the three-dimensional dataset using information of the registration.

In yet another aspect, disclosed herein is a computer-implemented system comprising: an image capturing device; a digital processing device comprising a processor, a memory, and an operating system configured to perform executable instructions, the digital processing device in digital communication with the image capturing device; and a computer program stored in the memory including instructions executable by the processor of the digital processing device to create application for updating CT scans of a subject, comprising: a software module configured to receive a three-dimensional dataset of the subject; a software module configured to generate a segmented three-dimensional dataset comprising: segment one or more vertebrae from the three-dimensional dataset; generate a plurality of single vertebra three-dimensional data using the one or more segmented vertebrae; and optionally combine the plurality of single vertebra three-dimensional datasets into a single three-dimensional dataset; a software module configured to acquire, by the image capturing device, two two-dimensional images of the subject taken from two intersecting imaging planes; a software module configured to generate three-dimensional coordinates for the two two-dimensional images using two-dimensional coordinates thereof; a software module configured to remove one or more metal objects from the two two-dimensional images, the one or more metal objects external to the one or more anatomical features, thereby generating two metal-free two-dimensional images; a software module configured to register the segmented three-dimensional dataset with the two metal-free two-dimensional images comprising: a) obtain a starting point, optionally automatically, using the three-dimensional dataset of the subject; b) generate a digitally reconstructed radiograph (DRR) from the segmented three-dimensional dataset; c) compare the DRR with the two metal-free two-dimensional images; d) calculate a value using a predetermined cost function based on the comparison of the DRR with the two metal-free two-dimensional images; e) repeat b)-d) until a predetermined stopping criterion is met; and f) output one or more DRRs based on the cost function; and a software module configured to update, by the computer, the three-dimensional dataset using the data used to create the one or more DRRs.

In yet another aspect, disclosed herein is non-transitory computer-readable storage media encoded with a computer program including instructions executable by a processor to create an application for updating three-dimensional medical imaging data, the media comprising: a software module configured to receive a three-dimensional dataset of the subject; a software module configured to generate a segmented three-dimensional dataset comprising: segment one or more anatomical features from the three-dimensional dataset; a software module configured to acquire, by the image capturing device, two two-dimensional images of the subject are taken from two intersecting imaging planes; a software module configured to generate three-dimensional coordinates for the two two-dimensional images; a software module configured to optionally remove one or more objects from the two two-dimensional images, the one or more objects external to the one or more anatomical features, thereby generating two object-free two-dimensional images; a software module configured to register the segmented three-dimensional dataset with the two object-free two-dimensional images; and a software module configured to optionally update the three-dimensional dataset using information of the registration.

In yet another aspect, disclosed herein is non-transitory computer-readable storage media encoded with a computer program including instructions executable by a processor to create an application for updating CT data of a subject, the media comprising: a software module configured to receive a three-dimensional dataset of the subject; a software module configured to generate a segmented three-dimensional dataset comprising: segment one or more vertebrae from the three-dimensional dataset; generate a plurality of single vertebra three-dimensional data using the one or more segmented vertebrae; and optionally combine the plurality of single vertebra three-dimensional datasets into a single three-dimensional dataset; a software module configured to acquire, by the image capturing device, two two-dimensional images of the subject are taken from two intersecting imaging planes; a software module configured to generate three-dimensional coordinates for the two two-dimensional images using two-dimensional coordinates thereof; a software module configured to remove one or more metal objects from the two two-dimensional images, the one or more metal objects are external to the one or more anatomical features, thereby generating two metal-free two-dimensional images; a software module configured to register the segmented three-dimensional dataset with the two metal-free two-dimensional images comprising: a) obtain a starting point optionally automatically using the three-dimensional dataset of the subject; b) generate a digitally reconstructed radiographies (DRR) from the segmented three-dimensional dataset; c) compare the DRR with the two metal-free two-dimensional images; d) calculate a value using a predetermined cost function based on the comparison of the DRR with the two metal-free two-dimensional images; e) repeat b)-d) until a predetermined stopping criterion is met; and f) output one or more DRRs based on the value of the predetermined cost function; and a software module configured to update, by the computer, the three-dimensional dataset using the one or more DRRs.

In yet another aspect, disclose herein is a method for updating three-dimensional (3D) medical images of a subject, the method comprising: optionally acquiring a 3D dataset of the subject using a first image capturing device, the 3D dataset containing a first anatomical feature, a second anatomical feature, or both; receiving, by a computer, the 3D dataset, wherein the 3D dataset optionally comprises a preoperative computerized tomography (CT) scan of a plurality of vertebrae; generating, by the computer, a segmented 3D dataset comprising: segmenting one or more vertebrae from the three-dimensional dataset; and generating one or more single vertebra three-dimensional datasets using each of the one or more segmented vertebrae, the one or more single vertebra 3D dataset comprising the first anatomical feature, the second anatomical feature, or both; optionally attaching one or more first tracking arrays to the subject, wherein the one or more first tracking arrays are attached to the first anatomical feature, the second anatomical feature, or both, wherein the one or more first tracking arrays are trackable by a second image capturing device; optionally attaching a second tracking array to an ultrasound imaging probe, wherein the second tracking array is trackable by the second image capturing device; acquiring, by the ultrasound imaging probe, one or more two-dimensional images of the subject while tracking the one or more first racking arrays, the second tracking array, or both by the second image capturing device; segmenting, by the computer, the first anatomical feature, the second anatomical feature, or both from the one or more two-dimensional images, wherein the first and second anatomical features optionally include a spinous process and a transverse process of a vertebra; optionally generating, by the computer, one or more undistorted two-dimensional images corresponding to the one or more two-dimensional images based on three-dimensional coordinates of the one or more two-dimensional images; transforming, by the computer, the segmented three-dimensional dataset or the single vertebra 3D dataset using a transformation matrix to reflect movement captured in the one or more undistorted 2D images after the acquisition of the 3D dataset comprising: obtaining a first transformation matrix between an ultrasound coordinate system and an imaging coordinate system using information of the first and second anatomical features therewithin; and obtaining a second transformation matrix between an ultrasound coordinate system and a tracking coordinate system using tracking information of the one or more first tracking arrays, the second tracking array, or both.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an exemplary embodiment of the systems, methods, and media herein for updating 3D medical imaging data of a subject using two or more 2D images of the same subject;

FIG. 2 shows an exemplary flow chart of the methods disclosed herein for updating 3D medical imaging data of a subject using two or more 2D images of the same subject;

FIGS. 3A-3B show exemplary steps included in segmentation of the vertebrae in the 3D medical imaging dataset, in accordance with embodiments herein;

FIGS. 4A-4A shows an exemplary embodiment of a single vertebra 3D dataset of the subject generated from the 3D medical imaging dataset of the subject in FIG. 5A;

FIG. 5A shows an exemplary embodiment of a 3D dataset with two vertebrae of the subject;

FIG. 5B shows an exemplary embodiment of a segmented 3D dataset including two vertebrae shown in FIG. 5A; the two vertebrae are combined together with a different transformation for each vertebra;

FIG. 6 shows an exemplary embodiment of a 2D image of the subject with opaque objects automatically identified;

FIGS. 7A-7B shows exemplary DRR images generated from the 3D medical imaging dataset of the subject;

FIG. 7C shows an exemplary 2D image with user's input on vertebra to be registered;

FIG. 7D shows an exemplary embodiments of the registration by matching the DRRs to the two 2D images of the subject, the initial DRR at the beginning of the registration can be a DRR assuming the patient is at a same position when the 3D medical imaging dataset and the two 2D images are taken;

FIGS. 8A-8B show different views of two registered vertebrae;

FIG. 8C shows the updated 3D dataset containing both the two vertebrae in FIGS. 8A-8B;

FIG. 9 shows a non-limiting example of the digital processing device as disclosed herein, in accordance with embodiments herein;

FIG. 10 shows an exemplary flow chart using the systems and methods disclosed herein;

FIG. 11 shows an exemplary embodiment of a segmented vertebra from the 3D dataset, an ultrasound image of the spinous process, and the tracking array(s) visible to an infrared image capturing device; in this case, the transformation for updating the 3D data for the vertebra includes a transformation from CT to ultrasound coordinate system, and a transformation from ultrasound to the infrared coordinate system; and

FIG. 12 shows an exemplary embodiment the segmented vertebra from the 3D dataset, an ultrasound image of the transverse process, and the tracking array attached to the ultrasound probe, which is visible to an infrared image capturing device; in this case, the transformation for updating the 3D data for the vertebra includes a transformation from a CT coordinate system to a ultrasound coordinate system, and a transformation from a ultrasound to an infrared coordinate system.

### DETAILED DESCRIPTION

Disclosed herein are systems, methods, and media for updating 3D preoperative images, e.g., CT scan, to include changes caused by patient movement. The advantages of the systems, methods, and media include no need to retake the 3D scan thus saves cost, time for the patient and surgeon. Further, the systems, methods, and media herein advantageously reduce ionizing radiation to the patient by only requiring as few as two 2D intraoperative images for updating the 3D scan. The updated 3D scan can correctly represent the current anatomical information during a medical operation, so that it can be used to assist the surgeon in making surgical moves and tracking surgical instruments relative to the anatomical features. As an example, the preoperative 3D dataset can be updated to reflect increased distance between two adjacent vertebrae caused by insertion of an implant therebetween, and the surgeon can rely on the updated 3D dataset to track pedicle screws or retractors for spine alignment or spinal fusion procedures. As disclosed herein the preoperative images and the intraoperative images can be taken with identical or different imaging modalities.

In some embodiments, disclosed herein is a method for updating three-dimensional medical imaging data of a subject, the method comprising: receiving, by a computer, a three-dimensional dataset of the subject; generating, by the computer, a segmented three-dimensional dataset comprising: segmenting one or more anatomical features in the three-dimensional dataset; acquiring, by an image capturing device, two two-dimensional images of the subject from two intersecting imaging planes; generating, by the computer, two undistorted two-dimensional images corresponding to the two two-dimensional images based on three-dimensional coordinates of the two two-dimensional images; optionally removing, by the computer, one or more objects from the two undistorted two-dimensional images, thereby generating two object-free two-dimensional images; registering, by the computer, the segmented three-dimensional dataset with the two object-free two-dimensional images; and optionally updating, by the computer, the three-dimensional dataset using information of the registration. In some embodiments, the three-dimensional dataset of the subject comprises a computerized tomography (CT) scan of the subject. In some embodiments, the CT scan of the subject is obtained before a medical operation when the subject is in a first position and the two two-dimensional images of the subject are taken when the subject is in a second position. In some embodiments, the one or more anatomical features comprise one or more vertebrae of the subject. In some embodiments, generating the segmented three-dimensional dataset further comprising, subsequent to segmenting the one or more anatomical features from the three-dimensional dataset, generating a plurality of single feature three-dimensional datasets using the one or more segmented anatomical features. In some embodiments, generating the segmented three-dimensional dataset further comprising, subsequent to generating the plurality of single feature three-dimensional datasets, combining the plurality of single feature three-dimensional datasets into a single three-dimensional dataset. In some embodiments, combining the plurality of single feature three-dimensional datasets comprising applying a transformation to each of the plurality of the single feature three-dimensional dataset. In some embodiments, the transformation comprises three-dimensional translation, rotation, or both. In some embodiments, generating the plurality of single feature three-dimensional data comprises smoothing edges of the anatomical features using Poisson blending. In some embodiments, segmenting the one or more anatomical features comprising using a neural network algorithm and automatically segmenting the one or more anatomical features by the computer. In some embodiments, the image capturing device is a C-arm. In some embodiments, a first of the two two-dimensional images of the subject is taken at a sagittal plane of the subject, and a second of the two-dimensional images is taken at a coronal plane of the subject. In some embodiments, the two intersecting imaging planes are perpendicular to each other. In some embodiments, generating the two undistorted two-dimensional images corresponding to the two two-dimensional images comprises using a marker attached to the one or more anatomical features, and generating one or more calibration matrices based on one or more of: two-dimensional coordinates of the two two-dimensional images, coordinates of the marker, position and orientation of the marker, an imaging parameter of the image capturing device, and information of the subject. In some embodiments, the two two-dimensional images include at least part of the marker therewithin. In some embodiments, the marker includes tracking markers that are detectable by a second image capturing device. In some embodiments, the second image capturing device comprises an infrared detector, and the tracking markers are configured to reflect infrared lights. In some embodiments, the one or more objects are opaque objects external to the one or more anatomical features. In some embodiments, removing the one or more opaque objects utilizes a neural network algorithm. In some embodiments, removing the one or more opaque objects is automatically performed by the computer. In some embodiments, registering the segmented three-dimensional dataset with the two object-free two-dimensional images comprising: obtaining a starting point optionally automatically using the three-dimensional dataset or the segmented three-dimensional dataset of the subject; generating a digitally reconstructed radiography (DRR) from the segmented three-dimensional dataset; comparing the DRR with the two object-free two-dimensional images; calculating a value of a cost function based on the comparison of the DRR with the two metal-free two-dimensional images; repeating b)-d) until the value of the cost function meets a predetermined stopping criterion; and outputting one or more DRRs based on the value of the cost function. In some embodiments, the information of the registration comprises one or more of: the one or more DRRs and parameters to generate the one or more DRRs from the segmented three-dimensional dataset. In some embodiments, the method further comprises displaying the updated three-dimensional dataset to a user using a digital display. In some embodiments, the method further comprises superimposing a medical instrument on the updated three-dimensional dataset to allow a user to track the medical instrument. In some embodiments, the two two-dimensional images of the subject are taken during a medical operation.

Disclosed herein, in some embodiments, is a method for updating three-dimensional (3D) medical images of a subject. The method may comprise acquiring a 3D dataset of the subject using a first image capturing device, the 3D dataset containing a first anatomical feature, a second anatomical feature, or both. The method may comprise receiving, by a computer, the 3D dataset, wherein the 3D dataset optionally comprises a preoperative computerized tomography (CT) scan of a plurality of vertebrae; generating, by the computer, a segmented 3D dataset comprising: segmenting one or more vertebrae from the three-dimensional dataset; and generating one or more single vertebra three-dimensional datasets using each of the one or more segmented vertebrae, the one or more single vertebra 3D dataset comprising the first anatomical feature, the second anatomical feature, or both. The method may include attaching one or more first tracking arrays to the subject, wherein the one or more first tracking arrays are attached to the first anatomical feature, the second anatomical feature, or both, wherein the one or more first tracking arrays are trackable by a second image capturing device. The method may include attaching a second tracking array to an ultrasound imaging probe, wherein the second tracking array is trackable by the second image capturing device. The method may include acquiring, by the ultrasound imaging probe, one or more two-dimensional images of the subject while tracking the one or more first racking arrays, the second tracking array, or both by the second image capturing device; and/or segmenting, by the computer, the first anatomical feature, the second anatomical feature, or both from the one or more two-dimensional images, wherein the first and second anatomical features optionally include a spinous process and a transverse process of a vertebra. The method may include generating, by the computer, one or more undistorted two-dimensional images corresponding to the one or more two-dimensional images based on three-dimensional coordinates of the one or more two-dimensional images. The method may include transforming, by the computer, the segmented three-dimensional dataset or the single vertebra 3D dataset using a transformation matrix to reflect movement captured in the one or more undistorted 2D images after the acquisition of the 3D dataset comprising: obtaining a first transformation matrix between an ultrasound coordinate system and an imaging coordinate system using information of the first and second anatomical features therewithin; and obtaining a second transformation matrix between an ultrasound coordinate system and a tracking coordinate system using tracking information of the one or more first tracking arrays, the second tracking array, or both.

### Certain Terms

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Overview

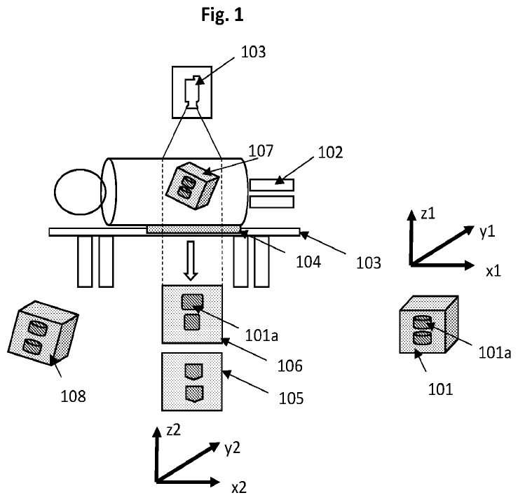

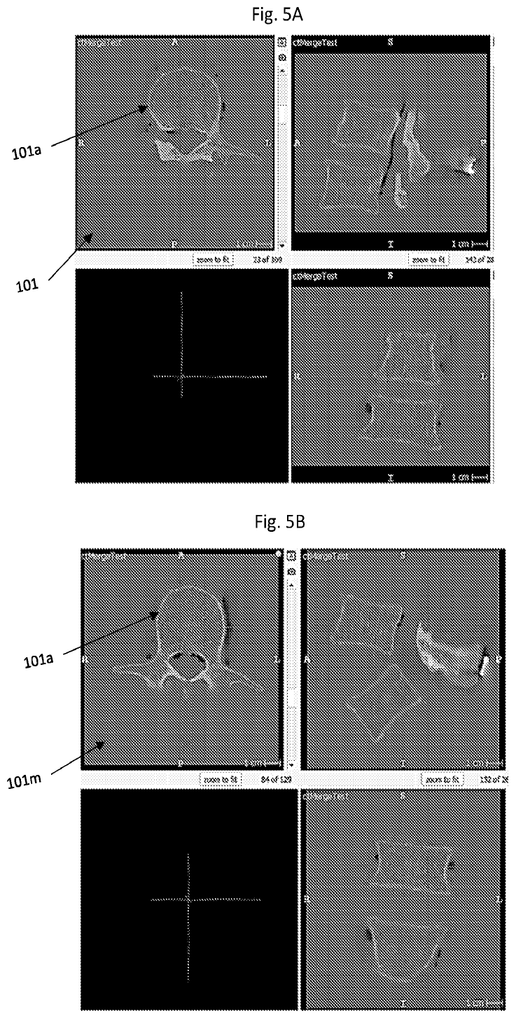

FIG. 1 shows a non-limiting exemplary embodiment of the systems, media, and methods disclosed herein for updating 3D medical imaging dataset of a subject, e.g., preoperative computerized tomography (CT) scan of the patient's spinal cord. In this particular embodiment, a 3D medical imaging dataset 101 is acquired in a first coordinate system defined by x1, y1, and z1. The 3D dataset 101 can be taken before a medical operation with one or more markers, thus when the patient 102 is positioned on a surgical table 110 in a ready position for the medical procedure, the patient has moved to a different position, and the relative position of the vertebrae has changed. In order to update the 3D medical imaging dataset 101 to correctly reflect changes in the patient's position and the relative movement between the vertebrae, two or more 2D images 105, 106 of the patient can be taken using the imaging capturing device 103 and the image sensor or detector 104. The 2D images may be in a different coordinate system determined by x2, y2, and z2. There can be translation and/or rotation between the two different coordinate systems, i.e., x1, y1, z1, and x2, y2, z2. In this particular embodiment, in order to register the 3D dataset 101 with the two 2D images, each vertebra 101a is segmented to generate multiple 3D datasets and each segmented dataset or 3D volume only includes a single vertebra 101s. The multiple 3D datasets can be optionally combined into a single 3D dataset 101m, e.g., a single 3D DICOM file. During their combination, each single vertebra dataset may be manipulated using a unique transformation matrix or function, as shown in FIGS. 5A-5B. In the same embodiment, the 2D images may be distorted and need to be calibrated to provide undistorted information. For calibration, 3D coordinates of the two 2D images 105, 106 of the subject can be generated using calibration matrix and 2D coordinates of the images. The calibration matrix may include an external matrix and an internal matrix combined by a mathematical operation, values in the matrix are based on imaging parameters of the image capturing device 103, 104 and/or information the patient. In the same embodiment, opaque objects that may cause inaccuracy in subsequent registration are removed from the calibrated 2D images. Subsequently, registration of the segmented 3D dataset with the 2D images can be performed by repetitively generating DRR image(s) 109 using the 3D segmented dataset as if the 3D dataset is rotated and/or translated 107 relative to the image capturing device 103, 104. The DRR image can be compared with the two 2D images until an optimization of match between the DRR and the 2D images is found, e.g., a stopping criterion is met. Then, the 3D dataset can be updated based on the DRR image(s) 109 to an updated 3D dataset 108.

### 3D Datasets

In some embodiments, the systems, methods, and media disclosed herein include a 3D dataset of a subject. The 3D dataset can be taken with any medical imaging modalities. Non-limiting examples of the imaging modalities include CT, MRI, ultrasound, (Positron-emission tomography) PET, and (single-photon emission computerized tomography) SPECT. The 3D dataset may be taken before a medical operation or before the patient has been positioned for a surgical procedure. Thus, the patient has moved between when the 3D dataset is taken and when the 2D images are acquired. As such, the 3D dataset may not correctly reflect anatomical information of the subject during a medical operation and can be misleading to the surgeon performing the operation.

In some embodiments, the 3D dataset may include one or more anatomical features of interest, e.g., a couple of adjacent vertebrae or even the whole spinal cord. In some embodiments, the 3D dataset includes a plurality of voxels in a coordinate system determined by x1, y1, and z1. The voxel size of the 3D dataset can be varied based on the anatomical structure to be imaged or the imaging modalities. The number of voxels in the x1, y1, z1 directions can also be varied based on the anatomical structure to be imaged and the imaging modalities. As an example, the 3D dataset may include 512 voxels along the x1 and z1 direction corresponding to the left to right and anterior to posterior directions of the patient, respectively, and 2056 pixels along the y1 direction corresponding to the head to foot direction. The voxels may be isotropic or non-isotropic. A length, width, or height of a voxel may be in the range of about 0.1 mm to about 1 cm. The 3D dataset may be in file format such as DICOM, so that the header of the dataset includes imaging parameters and positional parameters related to the image.

3D dataset disclosed herein can include one or more markers that are attached to the anatomical features. The position of the marker(s) with respect to the anatomical features remain constant so that the marker(s) can be used as a reference point to align images to the same 3D coordinate system which is the same coordinate system of the 2D images. In some embodiments, one or more markers are attached to each anatomical feature of interest.

In some embodiments, the 3D dataset herein includes original 3D registration between 3D preoperative CT scan and the infrared signal detected by the second image capturing device. In some embodiments, the 3D preoperative scan is obtained after the marker(s) is placed. The exact location and orientation of the marker inside the 3D scan are detected. Such detection may use a deep learning algorithm. In some embodiments, a deep learning algorithm is used to find clusters of voxels, each cluster may represent a marker candidate. The location and orientation of the marker can be used to calculate a transformation matrix between the infrared signal domain and the spatial domain of the 3D scan. The transformation matrix may be a 4 by 4 matrix.

### 2D Images

In some embodiments, the systems, methods, and media disclosed herein include two or more 2D images of a subject. The 2D images can be taken after the patient has been positioned for a surgical procedure so that the patient does not move after the 2D images are taken. If a patient moves after 2D imaging, a new set of 2D images can be taken after patient's movement to the new position to ensure that the 2D image reflects the patient's new positon and the anatomical feature in that position. The anatomical features in the 2D image can correctly reflect anatomical information of the subject during a surgical procedure so that they can be used to guide the surgeon or otherwise the user during the operation. In some embodiments, the 2D images may include one or more anatomical features of interest that are identical to those in the 3D dataset, although the relative position among the anatomical features may have changes in the 2D images due to the patient's movement. In some embodiments, the 2D images include a plurality of pixels, and the 2D images are generated in a 3D space determined by a coordinate system x2, y2, and z2. The pixel size can be varied based on the anatomical structure to be imaged or the imaging modalities. The number of pixels in the x1, y1, z1 directions can also be varied based on the anatomical structure to be imaged and the imaging modalities. As an example, the 2D images may include 512 voxels along the x1 and z1 direction corresponding to the left to right and anterior to posterior directions of the patient, respectively. The pixels may be isotropic or non-isotropic. A length or width of a pixel may be in the range of about 0.1 mm to about 1 cm. The 2D images may be in file format such as DICOM, so that the header of the dataset includes imaging parameters and positional parameters related to the image.

In some embodiments, the 2D images can be taken with any medical imaging modalities. Non-limiting examples of the imaging modalities include X-ray, CT, MRI, ultrasound, PET, and SPECT.

In some embodiments, the 2D images can be taken using the image capturing device disclosed herein, e.g., using ultrasound. In some embodiments, the 2D images can be taken by perform a sweep with the ultrasound in the inferior to superior direction to capture the spinous process. In some embodiments, the 2D images can be taken to include a transverse process.

In some embodiments, the 2D images can be taken using the image capturing device 103, 104 disclosed herein.

In some embodiments, the two 2D images can be taken from any arbitrary positions and orientations that are non-parallel and non-overlapping to each other. In some embodiments, the two 2D images are taken in two planes perpendicular to each other. The two images can include more than one vertebrae that are common to both images. As an example, if L4 and L5 are the vertebrae of interest and are included in the 3D dataset, at least part of each vertebra is included in a 2D image. In some embodiments, the two 2D images are taken at a sagittal plane and at a coronal plane of the patient.

In some embodiments, additional 2D images can be used. For example, two additional images that are about ±25 degrees from the sagittal or coronal view are also used.

In some embodiments, the 2D images are calibrated. In some embodiments, the 2D images are processed to become undistorted images.

One or more of the 2D images disclosed herein include a marker that is attached to the anatomical features. The position of the marker with respect to the anatomical features remain constant so that the marker can be used as a reference point to align images to the same 3D coordinate system which is the same coordinate system of the 3D segmented dataset. In some embodiments, the marker can be used as a reference in calibration and generation of the undistorted images. In some embodiment, one or more markers can be attached to each anatomical feature.

### Image Capturing Devices

The systems, methods, and media disclosed herein include an image capturing device 103, 104. The image capturing device can be any device that is capable of capturing data that can be used to generate a medical image of the subject. The image capture device can utilize one or more imaging modalities. For example, the image capturing device can include a Radiographic imaging device and an ultrasound imaging device. As another example, the image capture device can be an imaging scanner, such as an X-ray image intensifier or a C-arm. In some embodiments, the image capturing device can include a camera. The camera may utilize visible light, infrared light, other electro-magnetic waves in the spectrum, X-ray, or other sources.

In some embodiments, the image capturing device can include a Siemens Cios Spin machine or a General Electric C-arm.

In some embodiments, the image capturing device is in communication with the systems, methods, and media herein for data communication, or operational control of the image capturing device.

In some embodiments, the image capturing device includes an imaging sensor for detecting signal, e.g., visible light, x-ray, radio frequency (RF) pulses for generating the image(s). In some embodiments, the image capturing device includes one or more software modules for generating images using signal detected at the imaging sensor. In some embodiments, the image capturing device include a communication module so that it communicates data to the system, the digital processing device, a digital display, or any other devices disclosed herein.

### Anatomical Features

In some embodiments, the 3D dataset and the 2D images include one or more anatomical features that are identical, e.g., a same vertebra. In some embodiments, the anatomical features herein include a plurality of vertebrae. In some embodiments, the anatomical features herein include at least a portion of the spinal cord. In some embodiments, the anatomical features include at least a vertebra of the subject. In some embodiments, the anatomical features of the subject may translation or rotate when the patient moves but the anatomical features may not exhibit any deformable changes when the patient moves. For example, the vertebrae may rotate, translate due to movement, and the vertebrae may also have be removed partly for medical reasons, but the vertebra's general shape and size remain unaltered as the vertebrae are rigid and not flexible when the subject moves. Such characteristics of the vertebrae can be used in the systems, methods, and media disclosed herein. In some embodiments, the anatomical features include a portion of a vertebra, e.g., a spinous process.

In some embodiments, the anatomical feature can be any organ or tissue of the subject.

### Segmentation

In some embodiments, the systems, methods, and media disclosed herein utilize the 3D dataset to generate a segmented 3D dataset. The anatomical features are segmented in the segmented 3D dataset. In some embodiments, the outer contour or edges of the anatomical features are determined in the segmented 3D dataset.

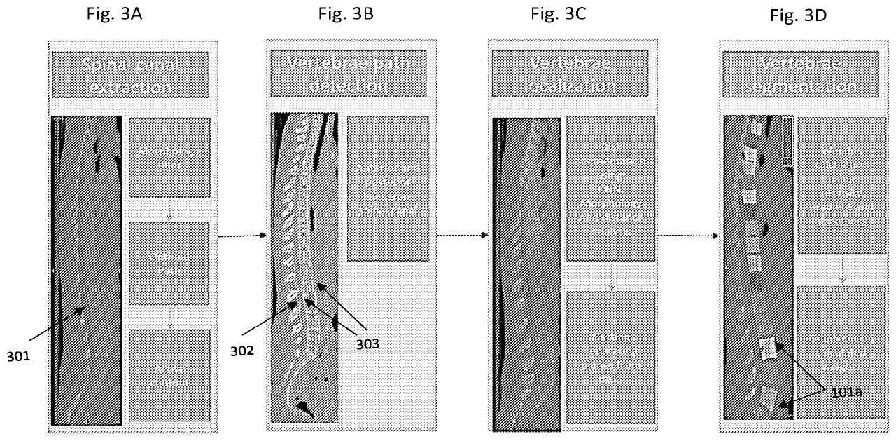

As shown in FIGS. 3A-3D, in an exemplary embodiment, segmentation of the vertebrae can be automatic, and can include one or more of spinal canal extraction, vertebrae path detection, vertebrae localization, and vertebrae segmentation. For spinal canal extraction, as shown in FIG. 3A, preprocessing of the canal may be performed in the axial plane, and the morphology of the canal in each axial slice of the 3D volume can be reconstructed and connected to complete the canal segmentation 301. Active contour can be used in this extraction process.

Based on the spinal canal segmentation, the posterior line 302 and anterior lines 303 of the vertebrae defined by the canal can be determined, as shown in FIG. 3B.

As in FIG. 3C, vertebrae can be localized by first detecting vertebral discs using a convolutional neural network algorithm and/or morphology information of the discs. Secondly, distance analysis can be used to find missing disc(s) or false detection(s). Based on the disc surface(s) identified, the separating planes between adjacent vertebrae can be determined.

As in FIG. 3D, vertebrae 101a are separated from surrounding tissue, e.g., canal and discs, and weighting can be added based on image intensity, intensity gradient, and sheetness of the 3D dataset to refine vertebrae segmentation.

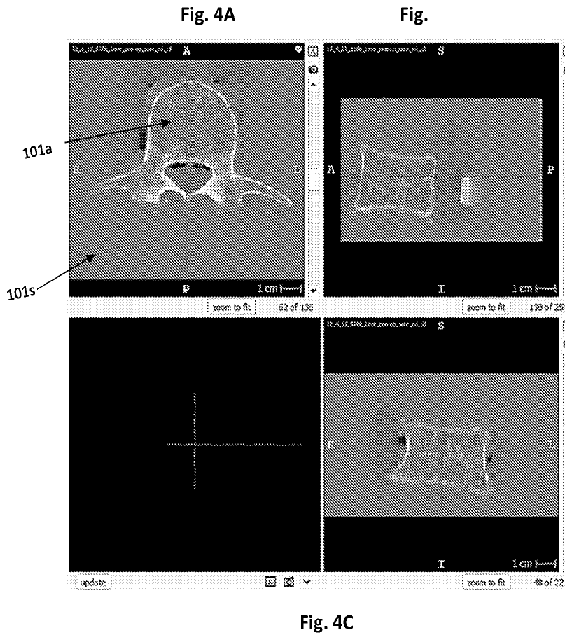

In some embodiments, the segmentation is for one vertebra, more than one vertebrae, or even each vertebra of the entire spinal cord. After segmentation, single vertebra 3D datasets can be generated for each vertebra that has been segmented. FIGS. 4A-4C show exemplary views of a single vertebra 3D dataset 404 with axial (FIG. 4a)), sagittal (FIG. 4b)), and coronal (FIG. 4c) views of the vertebra 304.

In some embodiments, the single vertebra 3D dataset 404 is created by cutting the relevant vertebra out based on the segmentation.

In some embodiments, the single vertebra 3D dataset 404 is generated using smoothening. For example, the 2D manifold that connects the edge of the segmented vertebra and other parts of the 3D data is smoothed out using Poisson blending.

Two or more single vertebra 3D datasets can be combined into a single dataset containing two or more vertebrae. The combination can include a unique transformation for each single vertebrae 3D dataset. The transformation can include 3D translation and/or 3D rotation relative to one dataset being combined or a reference coordinate system.

In some embodiments, one or more sub-steps in segmentation may implement a deep learning algorithm. For example, the 3D scan may be split into patches and a neural network may be used to segment each patch.

### Tracking Arrays

Disclosed herein are tracking arrays that can be attached to the anatomical features and to the ultrasound probe. The tracking arrays may be attached to the anatomical structure of interest, e.g., a vertebra. In some embodiments, the tracking array includes more than one tracking markers. The tracking markers can be located only on the outer surface of the tracking array. The relative position of two or more tracking markers, e.g., immediately adjacent markers, can be specifically determined so that each marker visible to the image capturing device can be uniquely identified. As such, the orientation and/or position of the medical instrument can be accurately determined based on the tracking information of more than one markers.

In some embodiments, the tracking array, e.g., the tracking markers are detectable by the image capturing device tracking markers detected are relative to the image capturing device.

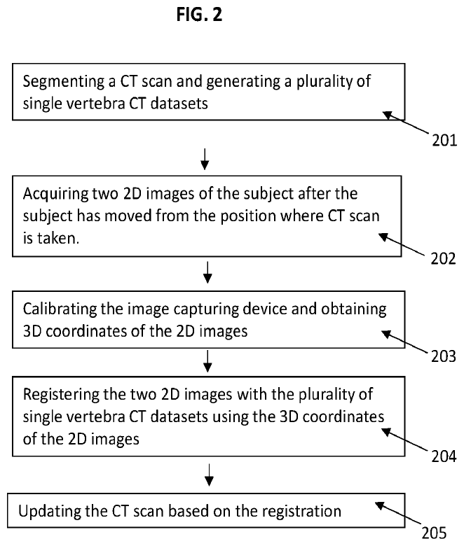

In some embodiments, the tracking arrays disclosed herein can be attached to an anatomical feature of the subject, a surgical tool, and/or a robotic arm. FIGS. 2-3 show one tracking array with three spherical tracking markers that can be attached to an ultrasound probe.

### Calibration

In some embodiments, the systems, methods, and media herein include calibrating the imaging capturing device so that the 2D images contain undistorted anatomical information of the patient.

In some embodiments, the two undistorted two-dimensional images corresponding to the two two-dimensional images are generated based on three-dimensional coordinates of the 2D images. The 3D coordinates can be obtained using the 2D coordinates of the 2D images, e.g., 2D coordinates for each pixel in the image, parameter(s) of the images such as pixel size, center point, information related to imaging parameter(s) of the image capturing device such as position and/or orientation of the camera, position of the x-ray source, and focal length.

In some embodiments, the calibration is performed and remains unaltered for a particular image capturing device.

The calibration herein can be configured to generate undistorted 2D images corresponding to the 2D images acquired by the image capturing device. The calibration herein may use a marker attached to the one or more anatomical features. The marker can remain fixed to the one or more anatomical features, e.g., fixedly but removably attached to a spinous process of a specific vertebra. The marker or at least part of the marker appear in one or more 2D images, and its location and orientation can be used as reference for aligning 2D images to the same 3D coordinate system. In some embodiments, the marker and its location and orientation information can be used to generate 3D coordinates of the 2D images. In some cases, the marker and its location and orientation information can be used for generating one or more calibration matrices that aligns the 2D image to the 3D coordinate system thereby generating the undistorted 2D images. The calibration matrix can include an internal matrix, an external matrix, or both. The 3D coordinates of the 2D images of the subject can be generated using calibration matrix and 2D coordinates of the images. The calibration matrix may include an external matrix and an internal matrix combined by a mathematical operation, values of the calibration matrix can be determined based on one or more of: 2D coordinates of the marker, location and/or orientation of the marker, parameters of the images such as resolution, field of view, center point, an imaging parameter of the image capturing device, such as focal length, location, or orientation of the camera, and information of the subject such as relative position to the camera.

In some embodiments, wherein the marker includes tracking markers that are detectable by a second image capturing device, the second image capturing device can include an infrared source, an infrared detector, or both. The tracking markers can be configured to reflect infrared lights that are detected by the second image capturing device.

In some embodiments, the tracking markers include a reflective surface or a reflective coating that reflects light in a specific electromagnetic frequency range. In some embodiments, the tracking markers are spherical or sufficiently spherical. In some embodiments, the markers are identical in size and shape. In other embodiments, the tracking markers can be of 3D shapes other than sphere and/or of sizes that are not identical. In some embodiments, two or more of the plurality of tracking markers comprise an identical shape, size, or both. In some embodiments, all of the plurality of tracking markers comprise an identical shape, size or both.

The tracking markers can be located only on the outer surface of marker(s). The relative position of two or more tracking markers, e.g., immediately adjacent markers, can be specifically determined so that each marker visible to the second image capturing device can be uniquely identified. As such, the orientation and/or position of the medical instrument can be accurately determined based on the tracking information of the more than one tracking markers.

### Removal of Opaque Objects

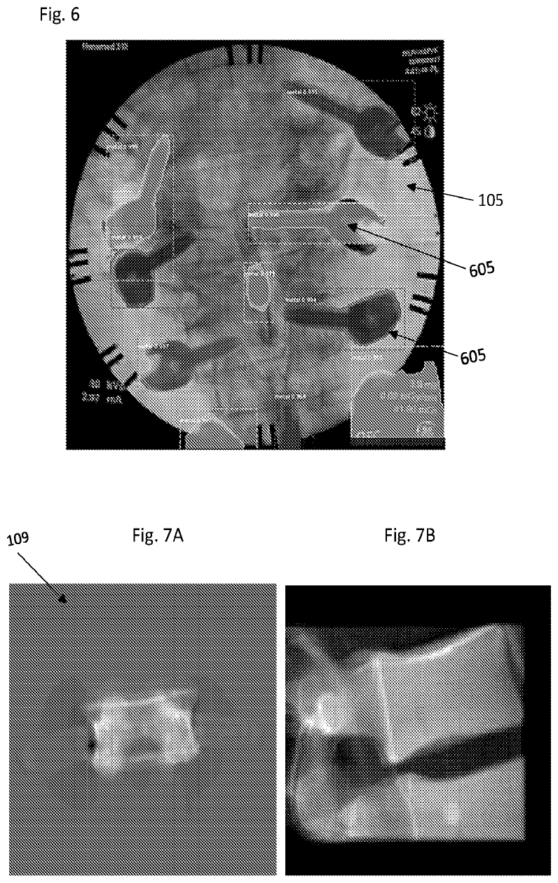

In some embodiments, the patient may include opaque objects that have been implanted permanently or temporarily. The opaque objects may appear dark in X-ray images. Non-limiting exemplary opaque objects include metal implants or any metal instruments that has been placed near the anatomical features of interest. FIG. 6 shows an undistorted 2D image with metal objects 605 that has been identified and masked for removal. The systems, methods, and media herein may remove such objects automatically. The systems, methods, and medial herein may utilize a neural network algorithm to identify and/or mask objects for removal. In some embodiments, a deep learning algorithm is used to identify and/or mask objects for removal.

The opaque objects may be removed by deleting the pixels that contains at least part of the opaque objects from consideration during registration. In some embodiment, the pixels that are partially occupied by opaque objects can also be removed. In some embodiments, the pixels removed from consideration during registration contains a value of zero.

As disclosed herein, the objects, instruments, and/or surgical tools herein are not limited to comprising only metal. Such objects, instruments, and/or surgical tools may contain any material that may be opaque or dense in a sense that they can obstruct or otherwise effect display of anatomical information. In some embodiments, when the imaging modality is radiography or X-ray related, the objects, instruments and/or surgical tools can be opaque. With other imaging modalities, the objects, instruments, and/or surgical tools may not contain any metal but may contain one or more types of other materials that obstruct or otherwise effect display of anatomical information.

In some embodiments, the metal objects herein are equivalent to opaque objects or dense objects with the specific imaging modality used. For example, the metal objects disclosed herein may comprise glass or plastic is opaque when the imaging modality is Ultrasound.

### Registration

In some embodiments, the systems, methods, and media disclosed herein include registration of the segmented 3D dataset with the 2D images so that the segmented 3D dataset can be updated to reflect changes in the anatomical features, e.g., translation and/or rotation caused by the patient's movement.

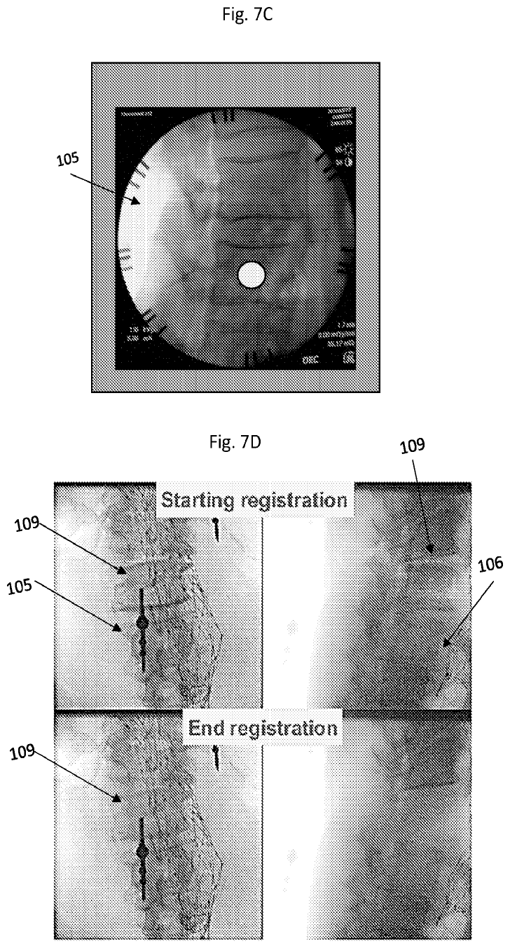

In some embodiments, the registration includes repetitively generating DRRs and evaluating each DRR using a predetermined cost function until the cost function is optimized thereby indicating an optimal match of the DRR to the 2D images. The optimal DRR then can be used to update the segmented 3D dataset. FIGS. 7A-7B show exemplary DRR images of vertebrae of the subject with different views. FIG. 7A is a coronal view, and FIG. 7B is a sagittal view.

In some embodiments, registration includes one or more sub-modules that can be used in combination. One sub-module can use output(s) of one or more other sub-modules as its input(s).

One sub-module, 6DOF, can be configured to create 6 degree of freedom parameter space in which pseudo quaternion (3 parameters) representation can be used for rotation. In some embodiments, the 6DOF module calculates 3D coordinate and orientation of the DRR, e.g., x, y, z, yaw, pitch, and roll. The 6DOF module can be configured to generate the back and/or forth transformations between registration matrices and compact 6 degree of freedom parameters space.

One sub-module, DRR generation module, can be used to repetitively generate DRRs based on the initial starting point (in the first iteration during optimization), or based on the previous DRRs and/or the previous value(s) of the cost function in later iterations during optimization.

In some embodiments, DRR generation module includes one or more inputs selected from: the original 3D dataset, e.g., the preoperative CT scan, the segmented 3D dataset, the single vertebra 3D dataset, parameters of the image capturing device such as position and orientation, parameter of the image such as image size, center point, and pixel size.

In some cases, the DRR generated herein is equivalent to rotating and/or translating the segmented 3D dataset relative to an image capturing device, e.g., X-ray source and X-ray detector, and acquiring 2D images based on the relative position thereof. The relative rotation and/or translation between the 3D dataset and the device can determine what is included in the DRR.

One sub-module can be configured to find a cost function that its extremum, e.g., a local minimum, may reflect the best or optimal alignment between the DRR's images and the 2D images. As an example, spatial gradient correlation between the DRR and the 2D images can be calculated and then the value of the cost function can be represented by a single score of the input parameters, e.g., x, y, z, yaw, pitch, and roll.

One sub-module can be configured to perform coarse optimization of the cost function, optionally after an initial starting point has been determined by a user or automatically selected by a software module. The coarse optimization module herein can use a covariance matrix adaptation evolution strategy (CMAES) optimization process which is a non-deterministic optimization process to optimize the cost function. The advantage can be that coarse optimization can avoid local minima and cover large search area. In some embodiments, optimization process other than CMAES can be used for coarse optimization.

One sub-module can be configured to perform fine-tuning optimization of the cost function, optionally after a coarse optimization has been performed. The fine-tuning optimization module can use gradient descent optimization process, a deterministic process, to optimize process that optimize the cost function. The advantage of the fine-tuning optimization can be that it is accurate and can fast find the best location for optimization, but it can be less robust at discriminating between global and local minima.

In some embodiments, the registration herein includes an optimization module that may use one or more optimization algorithms such as CMAES and gradient descent optimization. In some embodiments, the optimization module includes a coarse optimization module and a fine-tuning module. In some embodiments, optimization module used herein is not limited to CMAES and gradient descent optimization processes.

In some embodiments, the user is asked to provide an input using an input device to provide information related to the vertebrae to be registered. As shown in FIG. 7C, the user can directly click on the vertebra that needs registration with a dot in the undistorted 2D image either in a single view or multiple views. Registering only the vertebrae of interest may be advantageously save time and allow faster update of the 3D dataset.

Referring to FIG. 7D, in a particular embodiment, the initial starting point of the registration in different views is show in the top row, coronal view (top left) and sagittal view (top right). The superimposed images are DRRs that are superimposed on the 2D images. At the end of the registration, we can see the DRRs overlaps generally with the vertebra in the 2D images in both views in the bottom row.

In some embodiments, a number of 3D data files may be provide for registration, and each containing a single vertebra. Other information such as vertebra center, body to spinous process direction, and/or upper end plate direction of each vertebra may also be provided to facilitate registration. Such information can be automatically obtained in the segmentation process disclosed herein and then automatically input to the registration module or step. Other input to the registration process or step may include un-distorted 2D images including calibration matrix, internal matrix, and/or external matrix. The user input on the location of the vertebra on the 2D image(s) or undistorted image(s) can also be provided.

In some embodiments, the DRR may be output for updating the pre-operative 3D dataset. In some embodiments, the registration matrix which includes translation and rotation (e.g., yaw, pitch, roll) for each vertebra is output so that the user can later combine the vertebrae each modified by the registration matrix. The registration matrix herein is a transformation matrix that provides 3D rigid transformation of vertebrae or otherwise anatomical features of interest.

In some embodiments, the systems, methods, and media disclosed herein include registration of the segmented 3D dataset with the 2D images so that the segmented 3D dataset can be updated to reflect changes in the anatomical features, e.g., translation and/or rotation caused by the patient's movement. In some embodiments, the transformation herein is rigid body transformation.

In some embodiments, the 3D dataset includes a pre-operative CT scan and the 2D images include intra-operative ultrasound images. In some embodiments, the systems and methods herein eliminate radiation in the operation room, and also the need for lead apron during surgical operation to allow update of the pre-operative 3D data to reflect changes to the anatomical structures caused by patient's movement between when the 3D data is taken and when the patient is in a final position for surgery.

In some embodiments, the ultrasound images herein can detect useful vertebra boundaries that can be registered with a pre-operative CT scan, such as a spinous process or a transverse process of a vertebra. Such registration can be performed by optimizing a match between the spinous process in 3D and 2D images. In some embodiments, the registration uses an optimization algorithm. In some embodiments, the registration uses a machine learning algorithm such as a neural network or a deep learning algorithm. In some embodiments, the ultrasound probe can be tracked using the image capturing device, e.g., Optitrack, and thus can link the pre-operative CT to the Optitrack coordinate system.

### Updated 3D Datasets

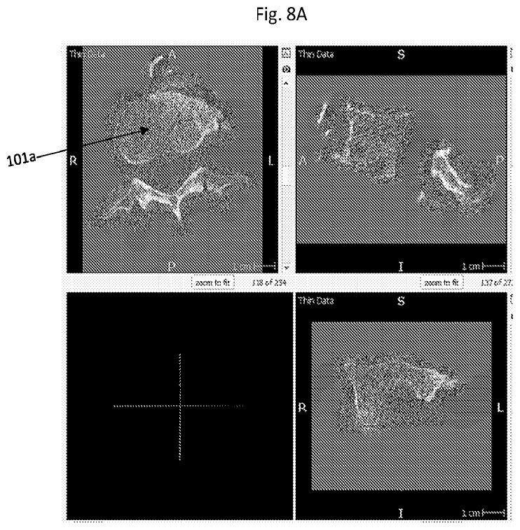

In some embodiments, after registration, the 3D dataset can be updated using information of the registration. Referring to FIGS. 8A-8C, in a particular embodiment, two adjacent vertebrae in FIGS. 8A-8B are registered. The axial (top left), sagittal (top right), and coronal views (bottom right) of each vertebra are shown. Based on registration information specific to the vertebra, e.g., 3D coordinates in a common coordinate system or x, y, z values and yaw, pitch, and roll, they can be combined to a single 3D volume including both vertebrae as shown in FIG. 8C in axial (top left), sagittal (top right), and coronal (bottom right) views. The updated 3D dataset 108 may reflect the current location and orientation of anatomical features after the patient movement from the previous location and orientation in the original 3D dataset. Thus, the updated 3D dataset 108 may provide accurate anatomical information of the patient for the surgeon during a surgical procedure, for example, for navigating or tracking surgical tools relative to the anatomical features to ensure accuracy of the operation.

In some embodiments, the updated 3D dataset is generated if requested by user. Two or more vertebrae can be merged into a single dataset, e.g., DICOM file, and their location and orientation may be based on the registration matrix that determines transformation in 3D for each vertebra.

### Method Steps

In some embodiments, disclosed herein is a method for or updating a 3D medical imaging dataset after the patient's position has changed. The methods disclosed herein may include one or more method steps or operations disclosed herein but not necessarily in the order that the steps or operations are disclosed herein.

FIG. 2 shows a non-limiting exemplary embodiment of the method steps for updating a 3D medical imaging dataset, e.g., a CT scan, of a subject using at least two 2D images, e.g., C-arm images.

In some embodiments, the methods disclosed herein include receiving a 3D dataset of the subject, e.g., a CT scan. The method may also include generating a segmented 3D dataset from the original 3D dataset 201 comprising: segmenting one or more anatomical features, e.g., vertebrae from the 3D dataset; generating a plurality of single vertebra 3D data using the one or more segmented vertebrae 201; and optionally combining the plurality of single vertebra 3D datasets into a single 3D dataset. In some embodiments, the methods include acquiring at least two 2D images of the subject from two intersecting imaging planes 202, for example, using a C-arm, and then generating undistorted 2D images corresponding to the 2D images based on three-dimensional coordinates of the images 203. Either before or after calibration, the methods herein can include removing one or more opaque objects from the images to generate opaque object-free 2D images. The methods can also include registering the segmented 3D dataset with the opaque object-free 2D images 204. The registering step 204 can include one or more of: a) obtaining a starting point optionally automatically using the 3D coordinates of the 2D images; b) generating a DRR from the segmented 3D dataset; c) comparing the DRR with the 2D images; d) calculating a value using a pre-determined cost function based on the comparison; e) repeating b)-d)) until the value of the cost function meets a predetermined stopping criterion; e) outputting one or more DRRs based on the value of the cost function. After registration, the methods disclosed herein can update the 3D dataset using the one or more DRRs 205.

In some embodiments, disclosed herein is a method for or updating a 3D medical imaging dataset after the patient's position has changed. The methods disclosed herein may include one or more method steps or operations disclosed herein but not necessarily in the order that the steps or operations are disclosed herein.

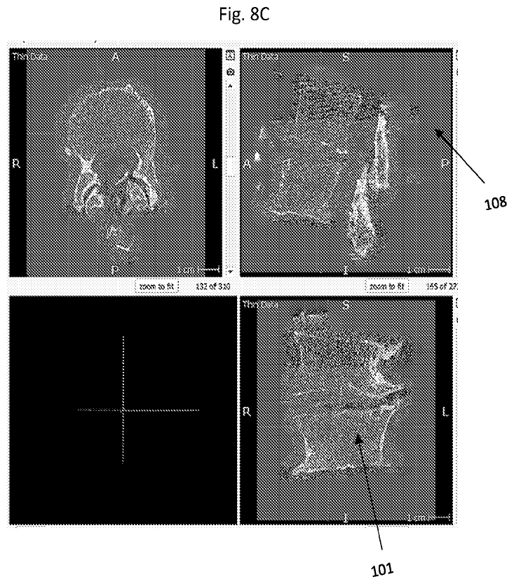

FIG. 10 shows a non-limiting exemplary embodiment of the method steps for updating a 3D medical imaging dataset, e.g., a CT scan, of a subject using one or more images, e.g., two 2D ultrasound images, or a 3D ultrasound volume.

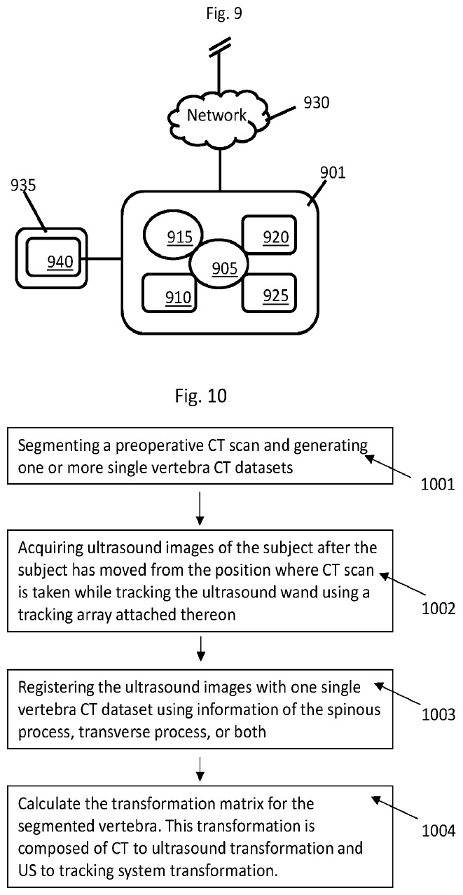

In some embodiment, before a subject is positioned for an operation, the systems and methods may include acquiring a 3D dataset of the subject using a first image capturing device, e.g., a CT scanner. The 3D dataset can contain one or more vertebrae, each vertebra can include a first anatomical feature and/or a second anatomical feature. The 3D dataset may be segmented by the computer to generate a segmented 3D dataset 1001. An example of segmented vertebra 101 is shown in FIG. 11. The segmentation can include segmenting one or more vertebrae from the three-dimensional dataset; and generating one or more single vertebra three-dimensional datasets using each of the one or more segmented vertebrae.

During a surgical procedure in the operation room, the systems and methods herein can include insert clamps and/or pins and plug tracking arrays to the pins and/or clamps so that they are fixedly attached to the vertebrae. The tracking array(s) can also be attached to the ultrasound probe to track its position. At this point, the patient' position or the relative position of the vertebrae may have changed, thus the pre-operative CT cannot be used directly for guiding surgical movement or surgical decisions. Thus, the pre-operative dataset may need to be updated.

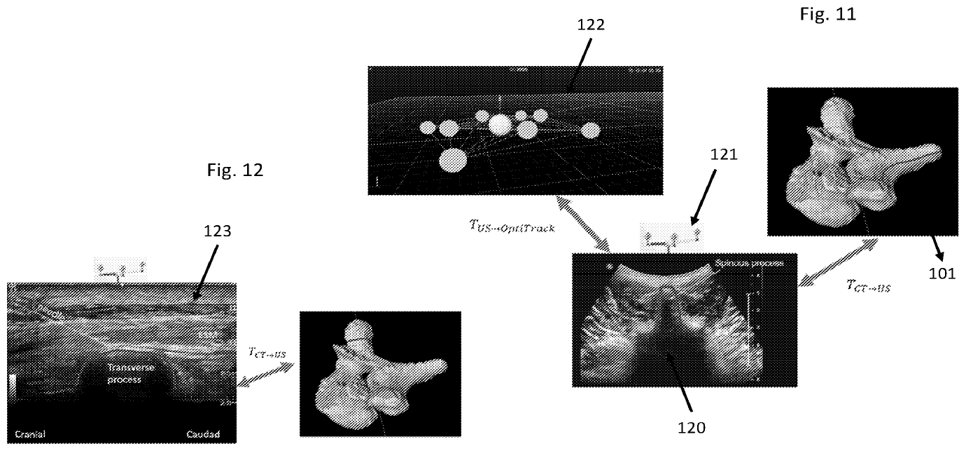

One or more vertebrae of interest can be selected, and for each vertebra, a user can perform a sweep with the ultrasound in specific 3D direction(s) 1002, e.g., in the inferior to superior direction to capture the spinous process. An exemplary mage of the spinous process 120 is shown in FIG. 11. The positional and orientation information of the ultrasound probe can be tracked during ultrasound imaging for example, using a tracking array 121 in FIG. 11. Such information is with reference to the image capturing device, e.g., the Opt track system, as image 122 shown in FIG. 11. FIG. 12 shows an ultrasound of the transverse process 123 and the same vertebra as shown in FIG. 11.

The acquired ultrasound image(s) can be registered to the 3D data 1003 by 3D rotation and translation, e.g., with six degree of freedom. The registration may indicate a transformation between the ultrasound coordinate system and the CT coordinate system. If more vertebrae need to be tracked, such segmentation and registration step can be repeated for each vertebra. Alternatively, registration can be performed for multiple vertebrae at the same time. In this case, the central vertebrae can be selected by a surgeon.

In some embodiments, the ultrasound images can be calibrated to obtain undistorted version of the vertebrae before the ultrasound and CT image registration.

In some embodiments, the systems and methods herein calculate a transformation matrix 1004 for the segmented vertebra or vertebrae. The transformation matrix can be used to update the 3D dataset and reflect changes caused by patient's movement between when the 3D dataset is taken and when the patient is positioned in the operation room for surgery. This transformation can include a transformation from the CT coordinate system to the ultrasound coordinate system and a transformation between the ultrasound coordinate system and the tracking coordinate system. In some embodiments, the method steps include transforming, by the computer, the segmented three-dimensional dataset or the single vertebra 3D dataset using a transformation matrix to reflect movement captured in the two undistorted 2D images after the acquisition of the 3D dataset. In some embodiments, the methods herein include obtaining a first transformation matrix between an ultrasound coordinate system and an imaging coordinate system using information of the first and second anatomical features therewithin. For example, the spinous process and/or the transverse process may include a set of coordinates in the ultrasound system, and a different set of coordinates in the 3D scan. After registration, these two different sets of coordinates can be linked to each other via a transformation matrix and a reverse transformation matrix. Such transformation matrix can be calculated using the different sets of coordinates. In some embodiments, the methods herein include obtaining a second transformation matrix between an ultrasound coordinate system and a tracking coordinate system using tracking information of tracking arrays. During operation, the ultrasound probe can be used to image the operated vertebra (the ultrasound image, e.g., 2D, can be linked and registered to the 3D data) and the tracking array attached to the ultrasound probe can indicate location of the operated vertebrae in a tracking coordinate system given that the probe to vertebrae distance and/or orientation information can also be obtained. As such, the same operated vertebra can be at set(s) of coordinates in the ultrasound coordinate system, and different set(s) of coordinates in the tracking coordinate system. These two different sets of coordinates can be linked to each other via a transformation matrix and a reverse transformation matrix. Such transformation matrix can be calculated using the different sets of coordinates. The transformation for updating the 3D dataset can include a combination of the transformation from the CT to the ultrasound coordinate system, and the transformation from the ultrasound to the tracking coordinate system. In some embodiments, the transformation can be matrix multiplication.

In some embodiments, at least 3, 4, 5, or even more points of coordinates are used for calculating a transformation matrix. In some embodiments, the points used may be the same to the tracking markers that are visible.

### Digital Processing Device

In some embodiments, the systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications.

In some embodiments, the digital processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

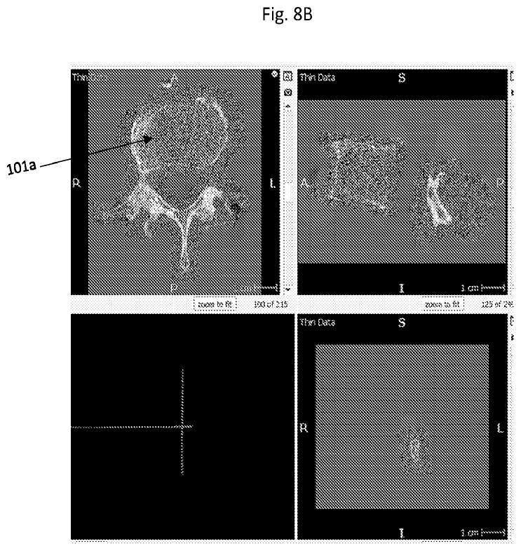

Referring to FIG. 9, in a particular embodiment, an exemplary digital processing device 901 is programmed or otherwise configured to estimate visual acuity of a subject. The device 901 can regulate various aspects of the algorithms and the method steps of the present disclosure. In this embodiment, the digital processing device 901 includes a central processing unit (CPU, also “processor” and “computer processor” herein) 905, which can be a single core or multi core processor, or a plurality of processors for parallel processing. The digital processing device 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The digital processing device 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the device 901, can implement a peer-to-peer network, which may enable devices coupled to the device 901 to behave as a client or a server.

Continuing to refer to FIG. 9, the CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and write back. The CPU 905 can be part of a circuit, such as an integrated circuit. One or more other components of the device 901 can be included in the circuit. In some embodiments, the circuit is an application specific integrated circuit (ASIC) or a field programmable gate array (FPGA).

Continuing to refer to FIG. 9, the storage unit 915 can store files, such as drivers, libraries and saved programs. The storage unit 915 can store user data, e.g., user preferences and user programs. The digital processing device 901 in some cases can include one or more additional data storage units that are external, such as located on a remote server that is in communication through an intranet or the Internet.

Continuing to refer to FIG. 9, the digital processing device 901 can communicate with one or more remote computer systems through the network 930. For instance, the device 901 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods or method steps as described herein can be implemented by way of machine (e.g., computer processor) executable code stored on an electronic storage location of the digital processing device 901, such as, for example, on the memory 910 or electronic storage unit 915. The machine executable or machine readable code can be provided in the form of software. During use, the code can be executed by the processor 905. In some embodiments, the code can be retrieved from the storage unit 915 and stored on the memory 910 for ready access by the processor 905. In some situations, the electronic storage unit 915 can be precluded, and machine-executable instructions are stored on memory 910.

The digital processing device 901 can include or be in communication with an electronic display 935 that comprises a user interface (UI) 940 for providing, for example, means to accept user input from an application at an application interface. Examples of UI's include, without limitation, a graphical user interface (GUI).

### Non-Transitory Computer Readable Storage Medium

In some embodiments, the systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some embodiments, the program and instructions are permanently, substantially permanently, semi-permanently, or non-transitorily encoded on the media.

### Computer Program

In some embodiments, the systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Software Modules

In some embodiments, the systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, and methods disclosed herein include one or more databases, or use of the same. In view of the disclosure provided herein, those of skill in the art will recognize that many databases are suitable for storage and retrieval of acuity chart, acuity sub chart, preliminary information of a subject, chart data of a subject, input and/or output of algorithms herein etc. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

Although certain embodiments and examples are provided in the foregoing description, the inventive subject matter extends beyond the specifically disclosed embodiments to other alternative embodiments and/or uses, and to modifications and equivalents thereof. Thus, the scope of the claims appended hereto is not limited by any of the particular embodiments described herein. For example, in any method disclosed herein, the operations may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the systems, and/or devices described herein may be embodied as integrated components or as separate components.

1. A method for updating three-dimensional medical imaging data, the method comprising:
receiving, by a computer, a three-dimensional dataset of a subject;
generating, by the computer, a segmented three-dimensional dataset, comprising:
segmenting one or more anatomical features in the three-dimensional dataset;
acquiring, by an image capturing device, two two-dimensional images of the subject from two intersecting imaging planes;
generating, by the computer, two undistorted two-dimensional images corresponding to the two two-dimensional images based on three-dimensional coordinates of the two two-dimensional images;
optionally removing, by the computer, one or more objects from the two undistorted two-dimensional images, thereby generating two object-free two-dimensional images;
registering, by the computer, the segmented three-dimensional dataset with the two object-free two-dimensional images; and
optionally updating, by the computer, the three-dimensional dataset using information of the registration.

2. The method of claim 1,
wherein the three-dimensional dataset of the subject comprises a computerized tomography (CT) scan of the subject; and
wherein the CT scan of the subject is obtained before a surgical procedure when the subject is in a first position and the two two-dimensional images of the subject are taken when the subject is in a second position.

3. (canceled)

4. The method of claim 1, wherein the one or more anatomical features comprise one or more vertebrae of the subject.

5. The method of claim 1,
wherein generating the segmented three-dimensional dataset further comprises:
subsequent to segmenting the one or more anatomical features from the three-dimensional dataset, generating a plurality of single feature three-dimensional datasets using the one or more segmented anatomical features; and
subsequent to generating the plurality of single feature three-dimensional datasets, combining the plurality of single feature three-dimensional datasets into a single three-dimensional dataset, wherein combining the plurality of single feature three-dimensional datasets further comprises applying a transformation to each of the plurality of the single feature three-dimensional dataset, wherein the transformation comprises a three-dimensional translation, a rotation, or both a three-dimensional translation and a rotation.

6.-9. (canceled)

10. The method of claim 1, wherein segmenting the one or more anatomical features comprises using a neural network algorithm and automatically segmenting the one or more anatomical features by the computer.

11. (canceled)

12. The method of claim 1, wherein a first of the two two-dimensional images of the subject is taken at a sagittal plane of the subject, and a second of the two-dimensional images is taken at a coronal plane of the subject.

13. The method of claim 1, wherein two intersecting imaging planes are perpendicular to each other.

14. The method of claim 1,
wherein generating the two undistorted two-dimensional images corresponding to the two two-dimensional images comprises using a marker attached to the one or more anatomical features and generating one or more calibration matrices based on one or more of: two-dimensional coordinates of the two two-dimensional images, coordinates of the marker, position and orientation of the marker, an imaging parameter of the image capturing device, and information of the subject.

15. The method of claim 14, wherein the two two-dimensional images include at least part of the marker therewithin.

16. The method of claim 14, wherein the marker includes tracking markers that are detectable by a second image capturing device.

17. The method of claim 16, wherein the second image capturing device comprises an infrared detector, and the tracking markers are configured to reflect infrared lights.

18. The method of claim 1, wherein the one or more objects are opaque objects external to the one or more anatomical features.

19. The method of claim 18, wherein removing the one or more opaque objects utilizes a neural network algorithm.

20. The method of claim 18, wherein removing the one or more opaque objects is automatically performed by the computer.

21. The method of claim 1, wherein registering the segmented three-dimensional dataset with the two object-free two-dimensional images comprises:
a) obtaining a starting point optionally automatically using the three-dimensional dataset or the segmented three-dimensional dataset of the subject;
b) generating a digitally reconstructed radiography (DRR) from the segmented three-dimensional dataset;
c) comparing the DRR with the two object-free two-dimensional images;
d) calculating a value of a cost function based on the comparison of the DRR with the two metal-free two-dimensional images;
e) repeating b)-d) until the value of the cost function meets a predetermined stopping criterion; and
f) outputting one or more DRRs based on the value of the cost function.

22. The method of claim 1, wherein the information of the registration comprises one or more of: the one or more DRRs and parameters to generate the one or more DRRs from the segmented three-dimensional dataset.

23. The method of claim 1, further comprising displaying the updated three-dimensional dataset to a user using a digital display.

24. The method of claim 23, further comprising superimposing a medical instrument on the updated three-dimensional dataset to allow a user to track the medical instrument.

25. The method of claim 1, wherein the two two-dimensional images of the subject are taken during a surgical procedure.

26.-31. (canceled)
